(19) United States
(12) Patent Application Publication
(10) Pub. No.: US 2010/0284640 A1
(43) Pub. Date: Nov. 11, 2010

(54) ROLLER BEARING

(75) Inventors: Gunnar Bergling, Savedalen (SE); Karl-Gustav Derman, Karna (SE)

Correspondence Address: DENNISON, SCHULTZ & MACDONALD, 1727 KING STREET, SUITE 105, ALEXANDRIA, VA, 22314, US

(73) Assignee: AGORA AB, Vaxjo (SE)

(21) Appl. No.: 12/516,584

(22) PCT Filed: Nov. 27, 2007
(86) PCT No.: PCT/SE2007/001052

§ 371 Date: Apr. 27, 2010

(30) Foreign Application Priority Data
Nov. 28, 2006 (SE) 0602533-2
Mar. 19, 2007 (SE) 0700712-3
Jun. 25, 2007 (SE) 0701549-8

(51) Int. Cl. F16C 19/04; F16C 33/42; F16C 43/00

(52) U.S. Cl. 384/490; 384/525; 384/537

(57) ABSTRACT

The invention is characterized by a rolling bearing and tools for its assembly, it being possible for the bearing to have the same external dimensions as conventional rolling bearings. The invention comprises rolling bearings, commonly of ball bearing type, for journaling rotating movements where the rolling elements can be made as spherical balls or rollers or any other form of rolling element that is advantageous. The invention also comprises a method for mounting of rolling bearings, commonly of ball-bearing type, for journaling rotating movements where the rolling elements can be spherical balls, rollers or any other form of rolling element that is advantageous. The mounting is effected by means of sleeves which are given a fork-shaped design.

### TECHNICAL FIELD OF THE INVENTION

The present invention relates to rolling bearings for journaling rotating components as shafts and similar machine components. These rolling bearings are partly built up by supporting bodies of a material that is cheaper but also lighter than the material that forms the raceways for the ball set. The material used to form the raceways can consist of helical spring material and has properties that give the bearing considerable wear capacity and life especially compared with the case when the supporting bodies with their simpler material also act as raceways for the balls.

### BACKGROUND OF THE INVENTION

It is well known how a ball bearing functions. Many tests have been carried out with simpler material than the steel alloys usually used for the manufacturing of ball bearings and roller bearings. In many cases, and particularly as regards stainless steel bearings, a cheaper and sometimes lighter bearing with high carrying capacity, can offer great advantages. Tests have been performed with different materials. There are available polymer bearings with same material also forming the raceways. These bearings have, however, limited carrying capacity, which besides is further decreased by temperature increases.

The present invention is a continued development of the rolling bearing that is defined in the Swedish patent “Rullningslager” numbered 513 139. Said patent teaches us a new way of bringing about a rolling bearing that is called D-ring bearing by its inventor Karl Gustav Derman. This bearing is well adapted for journaling a rotating flexible shaft as an example. A further development of the idea has resulted in those in this document described designs. The remarkable advantage is that these designs, together with the method of manufacturing the bearing, makes it possible to supply a cheap bearing with high dynamic as well as static carrying capacity independent of ordinary operating temperatures. With such a bearing, operating lives can be arrived at which are 50 times longer than the life obtainable with a corresponding bearing with rings made of polymer material only.

### Purpose and Characteristics of the Invention

The present invention aims at setting aside above mentioned disadvantages with earlier known technique and create a low price bearing, among other things with D-ring bearings made of stainless steel, with properties that are similar to those of conventional ball bearings and roller bearings. They offer a cheap alternative with high carrying capacity when stainless material is required.

The convex contacts of ball against three or four spring wires provide especially favourable conditions when the bearing operates in water. Tests have shown that, even under relatively high loads relative to the basic dynamic load rating of the bearing, fatigue of the spring wire raceways does not occur. A slight continuous wear of the raceways takes place, and replacement of the bearing is only needed when after a considerable operating time, the clearance of the bearing attains not acceptable limits. The wear particles are of micro size.

A new method involving special tools for mounting of said D-ring bearing makes it possible to manufacture a complete rolling bearing consisting of solid supporting rings and a D-ring bearing.

### Most Important Characteristics of the Invention

A D-ring bearing consists of two springs—an inner and an outer spring—which form raceways for a set of balls or as alternative a set of rollers. In a spring winding machine the inner spring 1 in FIG. 1 is formed such that it encloses and forms an inner raceway for the ball set 2, and the outer spring 3 is formed such that it encloses and forms an outer raceway for same ball set.

The springs 1 and 3 and the ball set 2 form a ball bearing unit, see FIG. 2, together with an inner supporting body 4 and an outer supporting body. The outer supporting body is here split and consists of the two components 5 and 6.

Alternative executions of the supporting bodies are also possible, and especially to advantage is to make even the outer supporting body 11 solid, according to FIG. 3, such that a complete groove ball bearing is produced. The supporting bodies 10 and 11 can be given dimensions that follow the standardized external dimensions for rolling bearings according to ISO.

The advantage with the designs in FIGS. 2 and 3 is that they bring about an easily assembled unit where the supporting bodies have deep grooves as support for the springs. The deep grooves make it possible to design the raceways of the springs such that they correspond to the raceways of single row deep groove ball bearings and by that give the bearing unit high carrying capacity for radial loads and axial loads in both directions.

### DESCRIPTION OF FIGURES

The invention will be described by mean of the following figures, where

FIG. 1 shows the components of the D-ring bearing, where

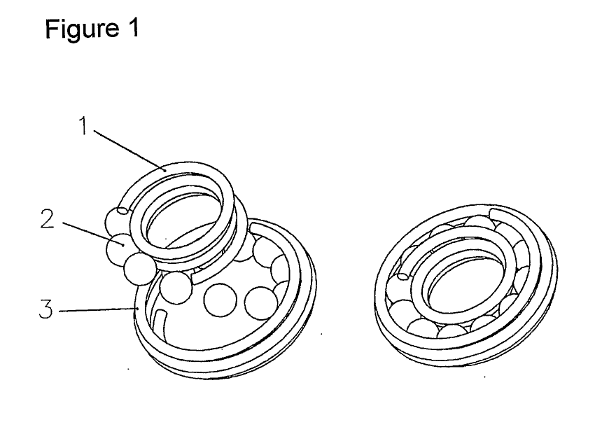

FIG. 2 shows a section of a bearing, where

FIG. 3 shows a section of a bearing, where

FIG. 4 shows a section of a mounting tool, where

FIG. 5 shows mounting tool, where

FIG. 6 shows tool with spring body, where

FIG. 7 shows tool with spring body, where

FIG. 8 shows tool with spring body, where

FIG. 9 shows mounting, where

FIG. 10 shows mounting, where

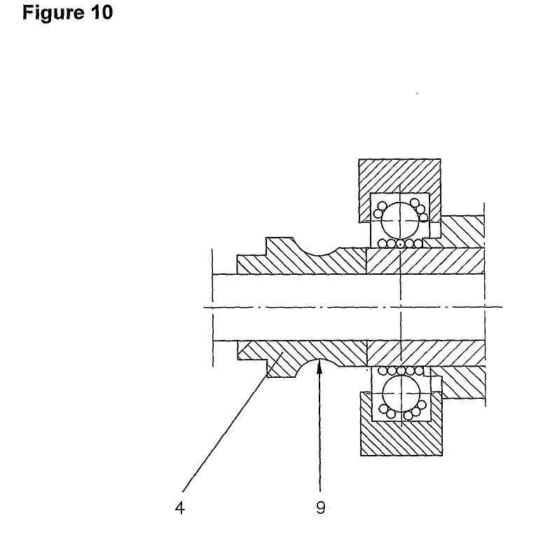

FIG. 11 shows mounting, where

FIG. 12 shows a section of a bearing, where

FIG. 13 shows mounting procedure, where

FIG. 14 shows a double row bearing, where

FIG. 15 shows a section of a bearing with seals, where

FIG. 16 shows a section of a double row bearing with seals, where

FIG. 17 shows a section of bearing, where

FIG. 18 shows a section of a double row bearing, where

FIG. 19 shows section of bearing as part of a complete component, where

FIG. 20 shows a section of a bearing

### PROBLEM

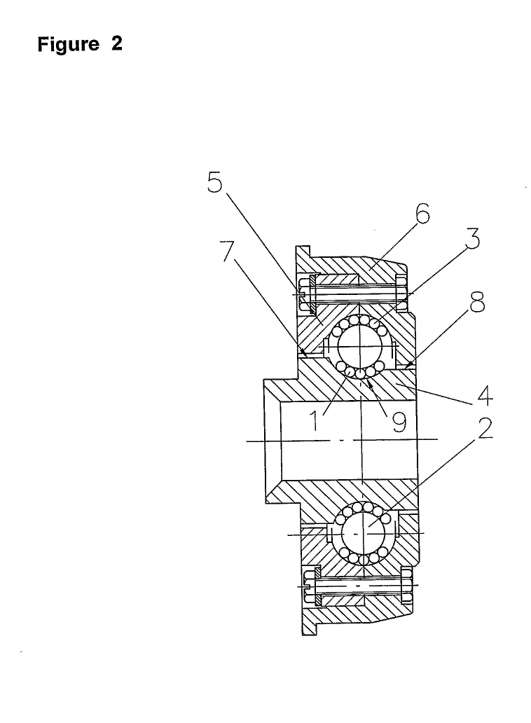

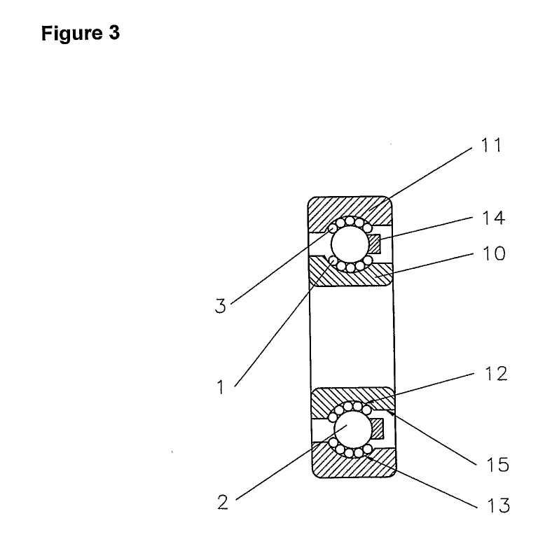

With two high shoulders, 7 and 8 in FIG. 2, it is very difficult to mount the inner spring 1 over one of the shoulders without besides damage the spring, even if the shoulder 8 e.g. is provided with an inclined surface to facilitate the mounting. This applies also for the mounting of the inner spring 1 over the shoulder 15 in FIG. 3.

This problem is solved by means of the invention, which makes the mounting of the inner spring 1 simple and besides makes it possible to give the spring a very tight fit against its groove after mounting to prevent creeping and ensure good aligning of the spring wires in the groove.

For the bearing in FIG. 3, the invention makes the mounting of the inner spring 1 into the groove 12 easy and the same applies to the outer spring 3 when it is mounted into the groove 13.

### THE INVENTION

The invention is characterized partly by tools for separate mounting of the inner and the outer springs of a D-ring bearing into their grooves in the supporting bodies and partly by the possibility of manufacturing complete rolling bearings consisting of a D-ring bearing and solid inner and outer supporting bodies.

### Tool for Mounting of the Inner Spring of a D-Ring Bearing

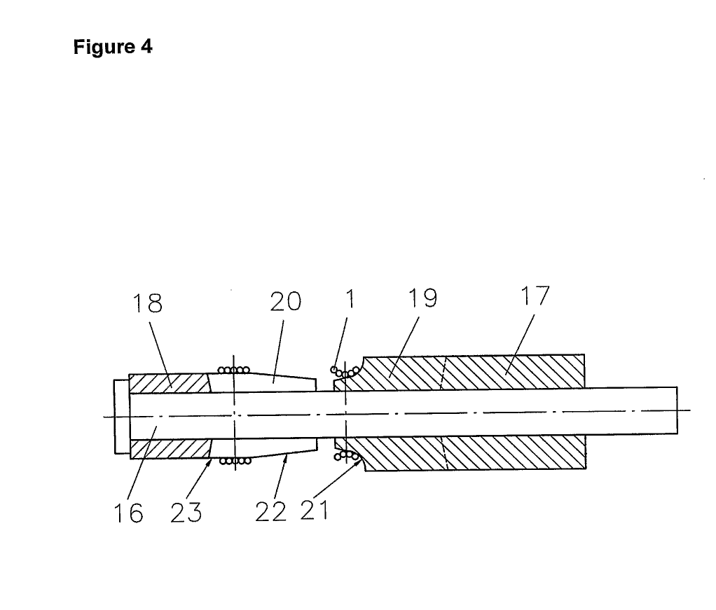

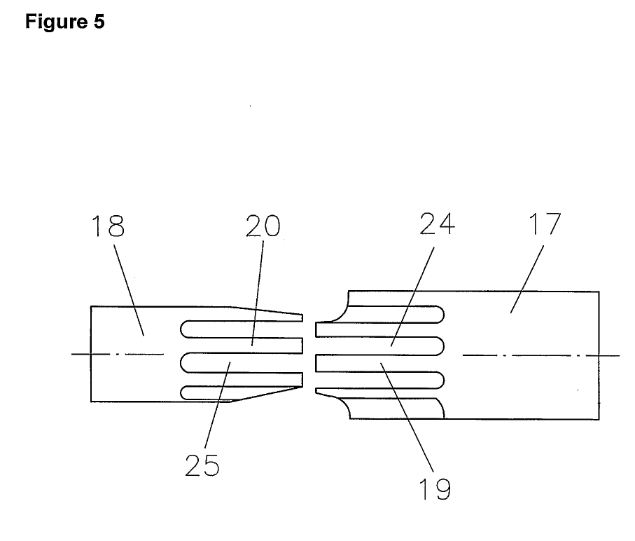

As an example the bearing according to FIG. 3 is selected. The invention is characterized by the sleeves 17 and 18 in FIG. 4. The sleeves are each provided with fork-shaped arrangements 19 and 20. The design of the prongs is shown schematically in FIG. 5, which indicates how the prongs 20 of one of the sleeves can be pushed into the gaps 24 between the prongs of the other sleeve, at the same time as the prongs designated 19 are pushed into the gaps designated 25.

The prongs of the sleeve 17 have supporting surfaces 21, which preferably have the same radius as the supporting surface 9 of the supporting body 4 in FIG. 2. The prongs of the sleeve 18 have preferably cone-shaped supporting surfaces 22.

When the inner spring in mounted, it is first placed on the supporting surfaces 21 of the sleeve 17 which, as well as the sleeve 18, is guided by the shaft 16.

The sleeve 17 is pushed axially into the sleeve 18, which is possible thanks to the fork-shaped arrangements. During this procedure, the spring 1 is driven up along the conical prong surfaces 22 onto the cylinder formed surface 23 of the sleeve 18. In FIG. 4 the spring is shown in this position.

During the driving up procedure, the spring gets full support all the time by the supporting surfaces 21 and 22 of the prongs 19 and 20, which makes a large expansion of the spring possible. By that a shoulder height 15 of the supporting body 10 of such a size can be accepted that an internal unit can be designed that has the same properties as the inner ring of a conventional deep groove ball bearing. The cylinder shaped surface 23 of the sleeve 18 has the same diameter as the shoulder 15 of the supporting body 10.

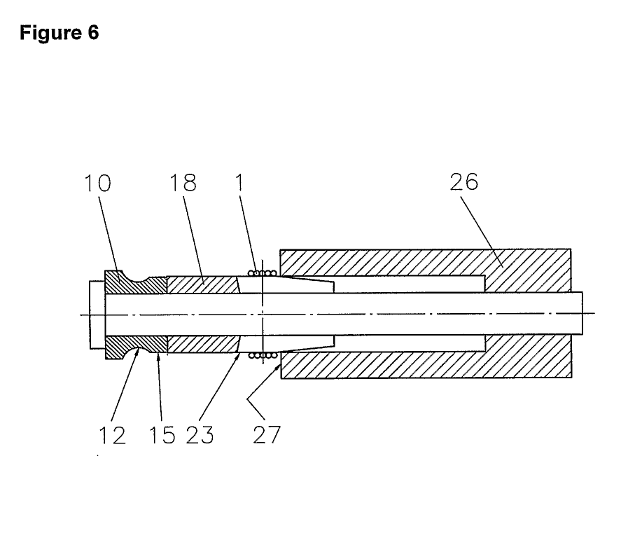

The pushing of the spring 1 into the groove 12 of the supporting body 10 after the spring has been driven up onto the cylindrical surface 23 is shown in FIG. 6, where the pushing is made by means of the cylinder 26.

The dimension of the inner diameter of the spring 1 is preferably determined such that the spring after mounting has a tight fit in the groove 12.

### Tool for Mounting of the Outer Spring of a D-Ring Bearing

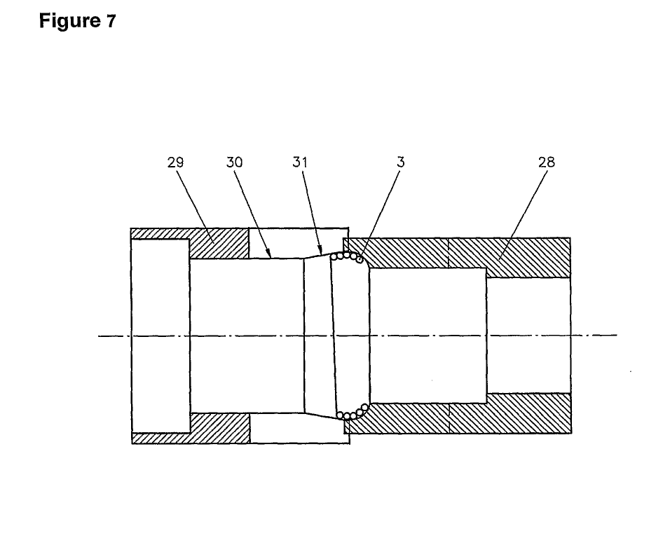

As an example the bearing according to FIG. 3 is selected. The invention is characterized by the sleeves 28 and 29 in FIG. 7. With the aid of these sleeves, which are provided with fork-shaped arrangements with the same purpose and design as described above for the sleeves 17 and 18 in FIG. 4, the outer spring 3 in FIG. 7 is driven up along the conical supporting surfaces 31 of the prongs down onto the cylindrical supporting surface 30 of the sleeve 29.

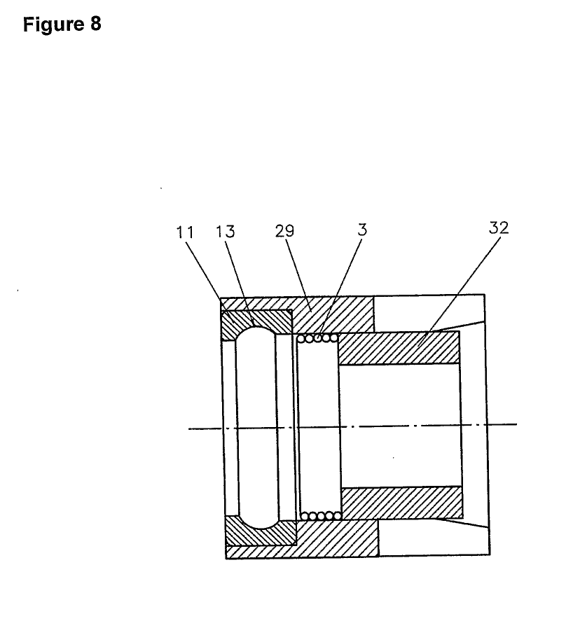

In the next operation the spring 3 is pushed, by means of the cylindrical sleeve 32 in FIG. 8, into the groove 13 of the supporting body 11. The depth of groove 13 can, thanks to the described mounting method, be selected such that an external unit can be designed with the same properties as the outer ring of a conventional deep groove ball bearing.

Arrangement for Mounting a Complete D-Ring Bearing into the Groove of an Inner Supporting Body

For certain bearing units, completely filled with balls and without cage, it is for line production to advantage to mount a complete D-ring bearing unit into the groove 9 of the inner supporting body 4 in FIG. 2 alternatively into the groove 12 of the supporting body 10 in FIG. 3.

The purpose of the invention is to prevent one or more balls from falling out when the inner spring is expanded during mounting and besides make the mounting work less sensitive to rough handling.

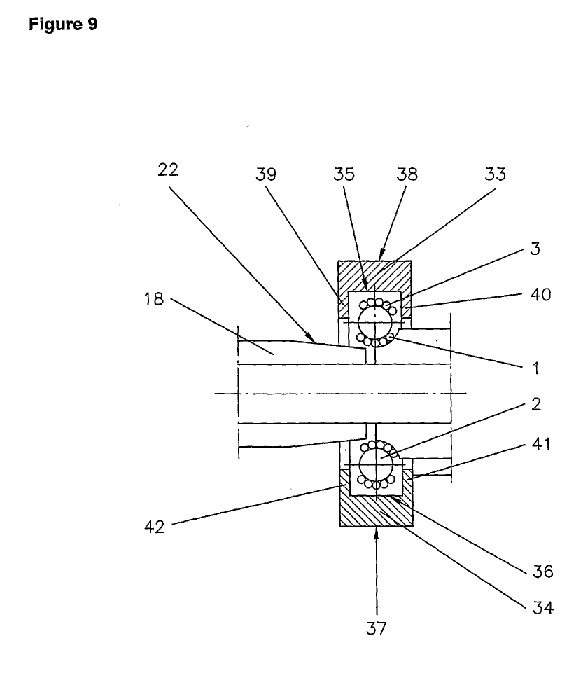

The invention is characterized by a split sleeve, which is built up by the components 33 and 34 in FIG. 9. The sleeve encloses the outer spring 3 with preferably cylindrical surfaces 35 and 36, which have a certain clearance in relation to the outer spring 3 in order to prevent direct contact between the cylindrical surfaces 35 and 36 and the outer spring 3 or the ball set when the complete D-ring bearing is driven up onto the conical supporting surfaces 22 of the prongs of the sleeve 18.

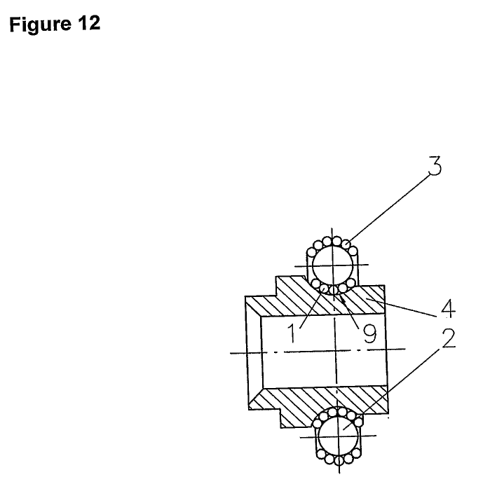

The components 33 and 34 of the sleeve are pressed against each other by a force, which can be brought about pneumatically, hydraulically or mechanically in line production such that they cover the outer spring 3 and the ball set. By this the balls 3 are prevented from falling out when the complete D-ring bearing is driven up along the conical supporting surfaces 22 of the prongs and then is pushed into the groove 9 of the supporting body 4. The driving up procedure is the same as shown in the FIGS. 4, 5 and 6, but the difference now is that a complete D-ring bearing is driven up and pushed into the groove 9 in FIG. 12.

The external dimensions of the split sleeve 37 and 38 can be cylindrical or given any other selected shape. The flanged ends of the sleeve 39, 40, 41 and 42 can be given the same shape as shown in FIG. 9 or any other shape that prevents the balls 2 from falling out during the mounting procedure.

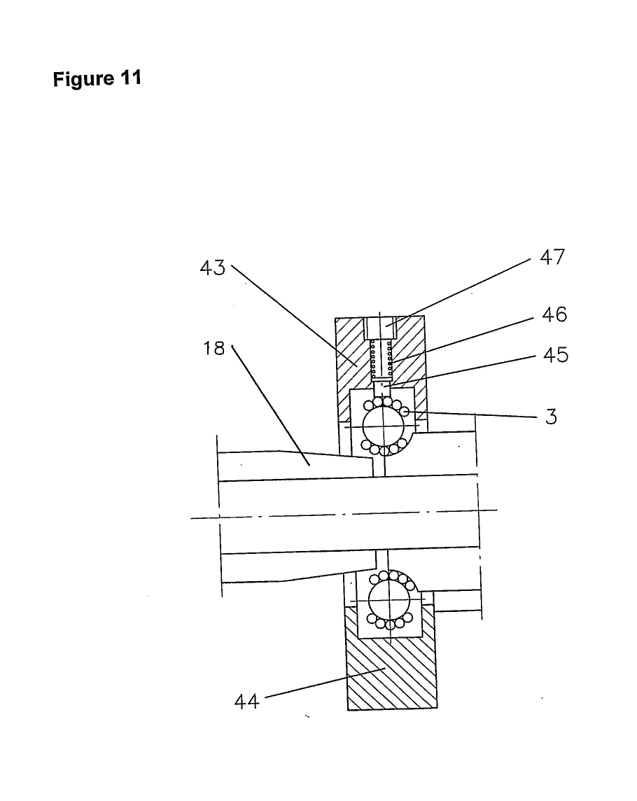

In FIG. 9 a radial clearance is shown between the outer spring 3 and the internal surfaces 35 and 36 of the sleeve. This design functions very well during mounting, but if a centering without clearance is required this can be easily be brought about by means of a spring device. This device can as in FIG. 11 consist of a number of very flexible preloaded helical springs 46 incorporated in components 43 and 44. The helical spring shown in FIG. 11 presses in one direction against s small piston 45, provided with a flange, and in the other direction against the screw 47. The preload of the helical springs is determined in relation to the weight of the components 43 and 44.

The length of the pistons is dimensioned such that zero clearance is obtained in relation to the outer spring 3. When the complete D-ring bearing is driven up along the conical supporting surfaces 22 of the sleeve 18, and the outer spring 3 then expands, the helical springs 46 make very little resistance.

### Ball Bearing Consisting of a D-Ring Bearing and Solid Inner and Outer Supporting Bodies

The invention applies to rolling bearings, e.g. according to FIG. 3 and is characterized by a D-ring bearing with springs which are supported by grooves in solid supporting bodies 10 and 11.

The springs 1 and 3 are brought into the grooves 12 and 13 of the supporting bodies by means of tools which are designed principally according to the FIGS. 4 to 8.

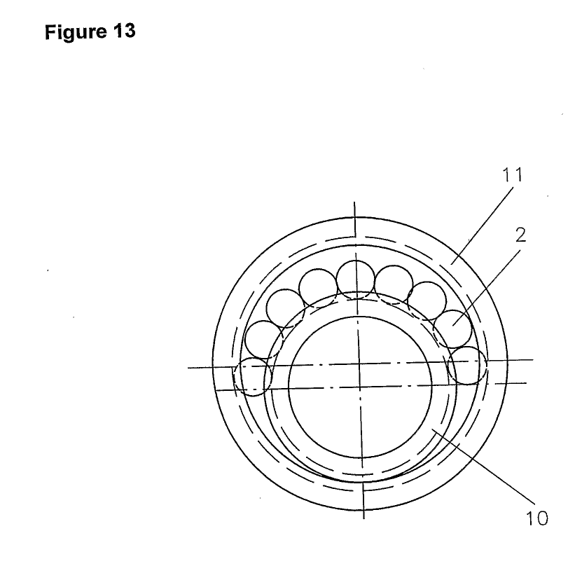

The balls 2 are then applied to the raceways of the springs 1 and 3 in the same way as used when mounting conventional groove ball bearings by placing the springs and their supporting bodies eccentrically according to FIG. 13.

After centering of the raceways, a cage 14 according to FIG. 3 is applied, preferably a snap type cage.

The invention applies to ball bearings manufactured in various executions with the same designing principles a shown in FIG. 3, with deep grooves in the solid inner and outer supporting bodies.

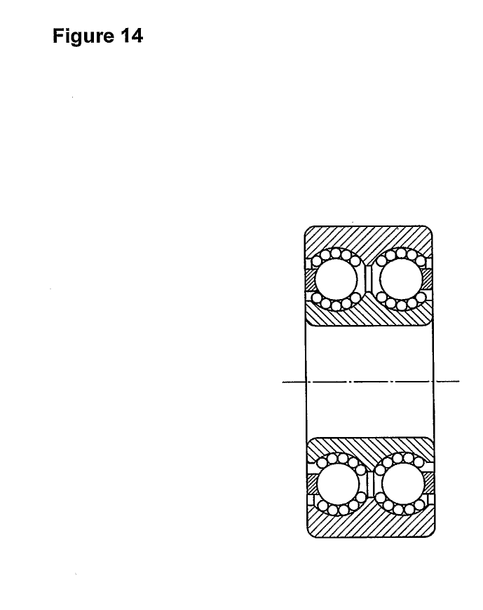

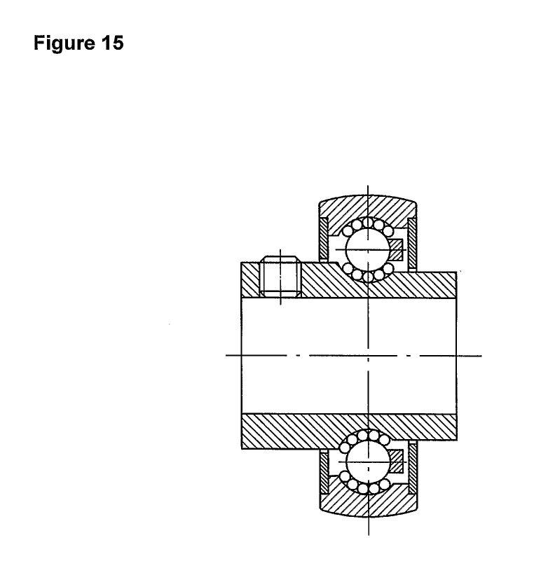

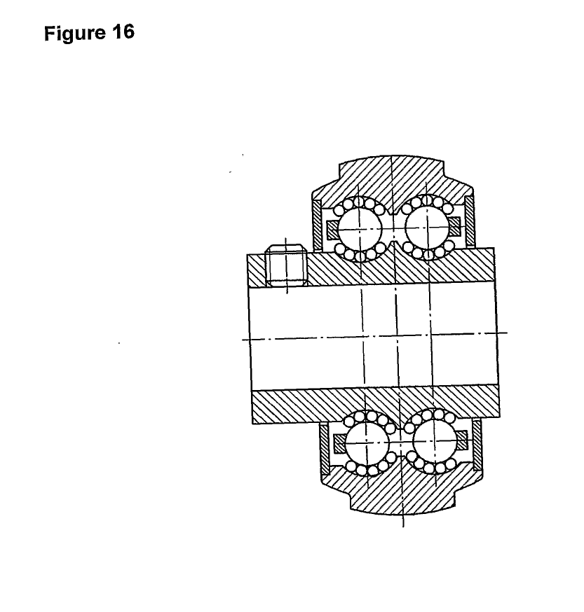

The bearings can be made single row as in FIG. 3, double row or multi-row. In FIG. 14 a double row groove ball bearing is shown. So called Y-bearings can be manufactured in single row execution, FIG. 15, as well as double row execution, FIG. 16. The Y-bearings are provided with seals and single row groove ball bearings according to FIG. 3 can also be delivered with one or two seals. The seals can be made of the same design as used for seals in conventional, sealed groove ball bearings.

Mounting of the inner and outer springs of D-ring bearings for double row bearings is carried out in the same way and with the same tools as being used for single row bearings.

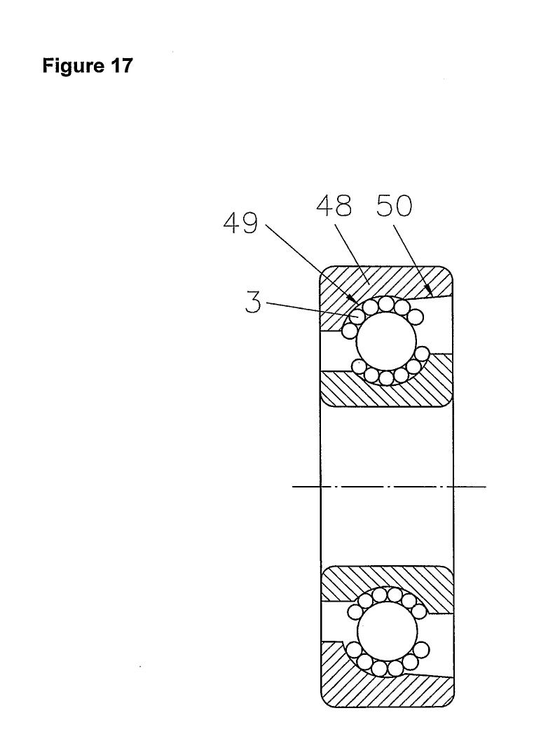

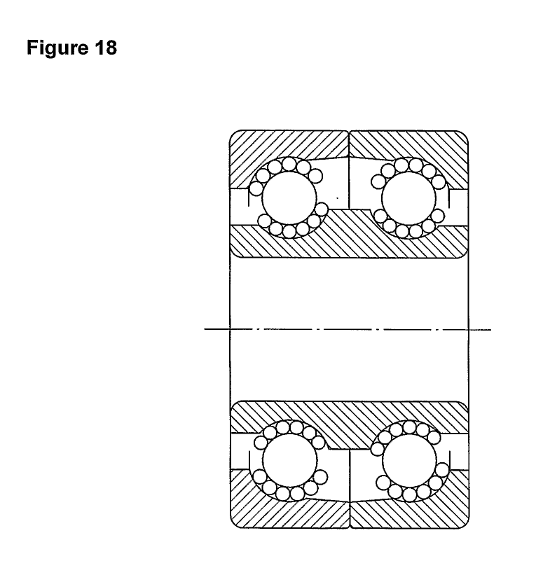

The invention also characterizes single and double row ball bearings with solid supporting bodies and with the bearings completely filled with balls and without cage, so called full complement ball bearings, see FIGS. 17 and 18. The inner supporting bodies of the bearings in FIGS. 17 and 18 have the same design of the supporting grooves as the corresponding groove of the bearing in FIG. 3, and the mounting of the inner springs is carried out for both bearing types in the same way as described for the mounting of the inner spring of the bearing in FIG. 3. Preferably, the invention according to FIG. 9 is applied, when a bearing according to FIG. 17 is assembled, with the complete D-ring bearing mounted directly into the groove of the inner supporting body. In FIG. 12 the result after assembly is shown.

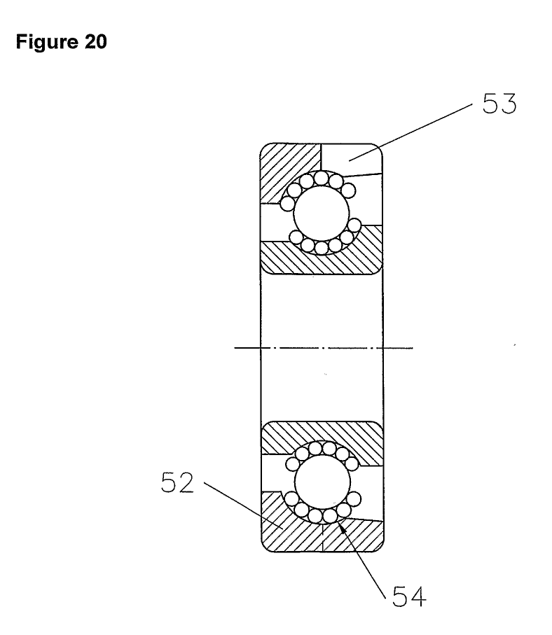

The outer supporting body 48 has a groove 49 with a low shoulder according to FIG. 17 and that also applies to FIG. 18. The external supporting body 50 is pushed over the outer spring with snap (the shoulder 50) or with another arrangement for keeping the bearing together. When a snap execution is used, the outer supporting body is heated up, in order to give the shoulder 50 clearance relative to the outer spring 3, when it is mounted. The snap function can also to advantage be made according to FIG. 20 with slitted openings 53 in order to facilitate the mounting, which then can be carried out without heating and with a higher shoulder 54, which improves the capacity to keep the bearing together. The single row bearings acts as angular contact ball bearings and shall only be axially loaded in one direction.

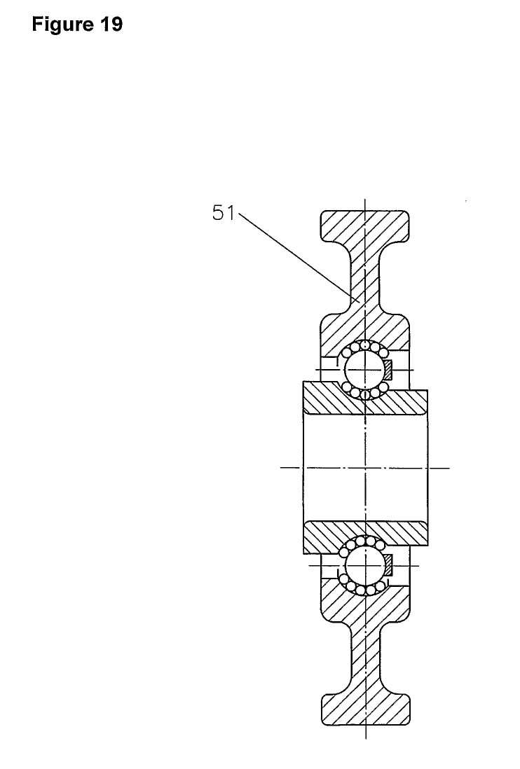

The invention is also characterized by D-ring bearings with solid supporting bodies or split supporting bodies, where one or both supporting bodies are formed such that a special function is fulfilled. One example is shown in FIG. 19, where the outer supporting body, in addition to its function as a bearing, also acts as the rotating part of a wheel.

The invention is also characterized by a D-ring bearing with or without cage which is mounted in a solid inner supporting body according to FIG. 12.

1. Rolling bearings, commonly of type ball bearings, for journaling rotating movements where the rolling elements can be made as spherical balls, rollers or given any other form of the rolling elements that will be to advantage.
Characterized in that the rolling elements (2) rolls against bodies (1,3) which enclose and form inner and outer raceways, that said bodies are made of other material than the material used for the supporting bodies (10, 11) which together with the bodies (1, 2, 3) build up the bearing, that the outer body (11) and the inner body (10), by their form provide support for said rolling elements (2) via the bodies (1, 3), that said bodies (1, 2, 3, 10 and 11) can be mounted during the manufacture of the bearing.

2. A rolling bearing as claimed in patent claim 1.
Characterized in that the surfaces of said bodies (1, 3) which enclose the rolling elements (2) have been given a surface treatment and or a choice of material that gives good strength and great power of endurance (long life) for said bodies subjected to loads from rolling elements (2), that said bodies (1, 3) can be given a spring type appearance, that said bodies (1, 3) enclose and form inner and outer raceways for rolling elements (2).

3. A rolling bearing claim 1.
Characterized in that said bodies (1, 3) which form raceways in said bearing to advantage can be made of winded wire of spring type, that said wire is winded and dimensioned to fit respective supporting body.

4. A rolling bearing claim 1.
Characterized in that the supporting bodies (10) and (11) preferably are solid but each body can also consist of more than one part.

5. A rolling bearing claim 1.
Characterized in that the bearing is provided with a cage, which can preferably be of snap type, that the bearing as an alternative is delivered without cage and completely filled with rolling elements.

6. A rolling bearing claim 1.
Characterized in that the bearing is provided with rolling elements (2) and spring bodies (1, 3) made of steel, stainless steel or other material that fulfils demands prescribed, that supporting bodies (10, 11, 4, 5, 6) are made of plastic or other material that fulfils demands prescribed.

7. A rolling bearing claim 1.
Characterized in that said supporting bodies (10, 11) can be integrated in and compose part of another component (51) of a product and by that simplify and reduce the manufacturing cost of said product, e.g. a wheel.

8. A rolling bearing claim 1.
Characterized in that said bearing can be manufactured in single row, double row or multi-row execution.

9. A rolling bearing claim 1.
Characterized in that said supporting bodies can be given external dimensions that follow the dimensional standards for rolling bearings according to ISO.

10. A rolling bearing claim 1.
Characterized in that the bearing, with its convex contacts between stainless steel spring wires (1, 3) and stainless steel balls (2), when operating with liquids as water as lubricant is only subjected to slight continuous wear of the raceways of supporting bodies (1, 3) and balls (2) without getting detrimental fatigue of said raceways and balls.

11. A method for mounting of rolling bearings, commonly ball bearings, used for journaling rotating movement where the rolling elements can be spherical balls, rollers or rolling elements containing any other form that will be to advantage.
Characterized in that the mounting of inner spring (1) is carried out by means of sleeves (17, 18) which are given a fork-shaped design with prongs where the prongs (19, 20) can be pushed into the gaps (24, 25), that the prongs of the sleeve (18) have preferably cone-shaped supporting surfaces (22) to facilitate the driving up of inner spring (1) when the sleeves (17, 18) are pushed together during this procedure.

12. A method for mounting of rolling bearings claim 11.
Characterized in that the mounting of outer spring (3) is brought about by means of the fork-shaped sleeves (28, 29) in the same way as preceding claims.
